(19) United States
(12) Patent Application Publication
(10) Pub. No.: US 2005/0059276 A1
(43) Pub. Date: Mar. 17, 2005

(54) Connector with solder-bearing contact

(76) Inventors: Gen-Sheng Lee, Tu-Chen (TW); Ming-Lun Szu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/940,133

(22) Filed: Sep. 13, 2004

(30) Foreign Application Priority Data
Sep. 12, 2003 (TW) 92216484

(51) Int. Cl. H01R 12/00

(52) U.S. Cl. 439/83

(57) ABSTRACT

An electrical connector includes an electrically insulative housing having a plurality of passageways and an identical number of contacts. Each contact has an solder portion connected with a solder ball. The solder portion has at least two solder faces which are perpendicular from each other. The solder faces are partly engaged into the solder ball and soldered with the solder ball.

### BACKGROUND OF THE INVENTION

1. Field of the Invention

The present invention relates to a conductive contact soldered with a quantity of solder, especially to such a contact which is used in a ball grid array (BGA) connector.

2. Description of Prior Art

Today, it is well known in the field of electrical connector that there are usually two kinds of contacts used in the electrical connector for connecting integrated circuit (IC) package to printed circuit board (PCB), i.e. pin-foot-like contact which used for pin grid array (PGA) socket and soldering-ball contact which used for ball grid array (BGA) socket. With the rapid development of manufacturing technology, solder-ball-planting technique has been developed and now is widely used, which makes surface-mount-assembling contact popular for connecting PCB. This technique is disclosed both in U.S. Pat. No. 6,095,842, published on Aug. 1, 2000, and in U.S. Pat. No. 6,099,321, published on Aug. 8, 2000. The contact in this technique is associated with a quantity of solder at one end so that after the contacts are juxtaposed to a substrate (usually with a corresponding conductive face areas or pads to which the contacts to be connected) and then the assembly is heated, the solder is partly molten and the molten portion covers the juxtaposed contacts and the substrate to form, when cool, soldered joints serving as electrical and mechanical connections between the contacts and the substrate.

Referring to FIG. 6, a solder-ball-bearing contact of a conventional connector is shown. The contact defines a soldering portion with a planar bottom face. A solder ball is attached to the bottom face and then soldered to the contact.

However, just before attaching the solder to the contact, a kind of adhesive flux is needed to be applied over the bottom face of the contact in order to help the contact and the solder adhering to each other. Conventionally, the flux is apt to be applied by error to an unwanted portion of the contact, thereby adversely affecting the electrical connection between the contact and the complementary electrical element. In addition, another disadvantage of the present technique is that the planar soldering face formed between the contact and the solder may easily lead to metal fatigue. As a matter of experience, metal fatigue arises more easily at the soldering position. Under alternate stress, the void coalescence in the soldering connection leads to crack and then the crack grows straightly along the bottom face leading to metal fatigue.

So a new connector that overcomes the above-mentioned problems is desired.

### SUMMARY OF THE INVENTION

An object of the present invention is to provide a connector, each contacts of which can be conveniently associated with a mass of solder without any adhesive flux.

Another object of the present invention is to provide a connector, each contacts of which is associated with a mass of solder, wherein the connection between the contact and the solder is less susceptible to crack which may lead to metal fatigue eventually.

In order to achieve the above objects, a connector in accordance with a preferred embodiment of the present invention comprises a housing having a plurality of passageways, an identical number of electrical conductive contacts received in said passageways. Each contact defines an solder portion connected with a solder ball. The solder portion defines at least two solder faces perpendicular to each other. The at least two faces form at least a sharp point. When push the solder ball against the soldering portion, the sharp point and part of the solder faces are engaged into the solder ball so the solder ball gets stuck to the contact. After soldering the solder ball to the contact, when in work, cracks may produce and extend along one of the soldering face, then they will meet the base inner solder that is less susceptible to cracks, which will delay further straightly developing of the crack.

Other objects, advantages and novel features of the present invention will become more apparent from the following detailed description when taken in conjunction with the accompanying drawings, in which:

### BRIEF DESCRIPTION OF THE DRAWINGS

FIG. 1 is an assembled view of a connector in accordance with the preferred embodiment of the present invention;

FIG. 2 is an isometric view of a contact in accordance with the preferred embodiment of the present invention, showing a discrete solder ball and molds in open position;

FIG. 3 is a partly cross-sectional side view of the contact of FIG. 3, showing the solder ball partly wedged into the solder portion of the contact;

FIG. 4 is the same view as FIG. 4, except that the solder has been soldered with the contact is a partly cross-sectional side view of the contact of FIG. 3, showing the solder ball partly wedged into the solder portion of the contact;

FIG. 5 is an isometric view of a contact in accordance with an alternative embodiment of the present invention, with a discrete solder ball; and

FIG. 6 is an isometric view of a solderball-bearing contact of a conventional connector.

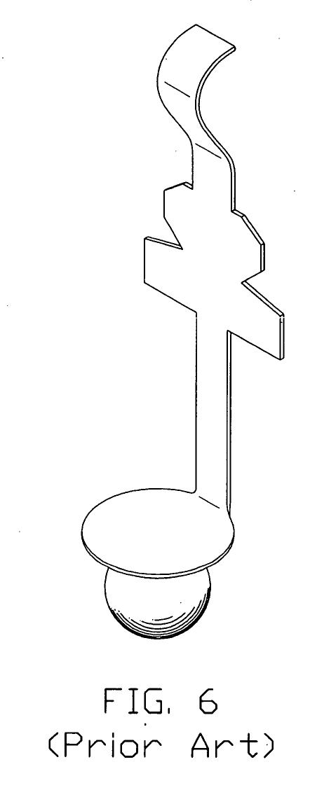

### DESCRIPTION OF THE PREFERRED EMBODIMENT

Reference will now be made to the drawings to describe the present invention in detail.

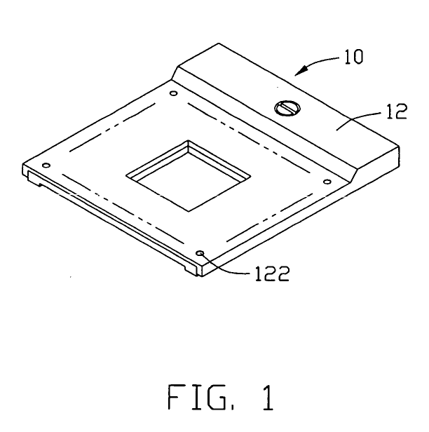

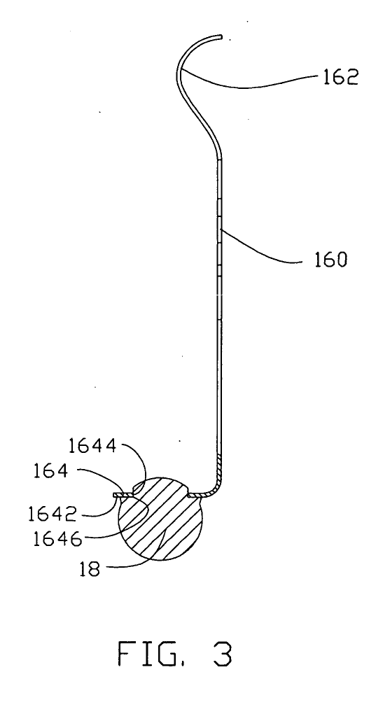

Referring to FIG. 1, a connector 10 in accordance with the preferred embodiment of the present invention is shown. The connector 10 is to be soldered to a PCB (not shown) so as to connect an integrated circuit (IC) package with pin-foot-like contact, such as a central processing unit (CPU) (not shown) to the PCB. The connector 10 comprises a electrically insulative housing 12 with a plurality of passageways 122 arrayed therein and a plurality of electrically conductive contacts 16 (shown in FIG. 3) received in the corresponding passageways 122.

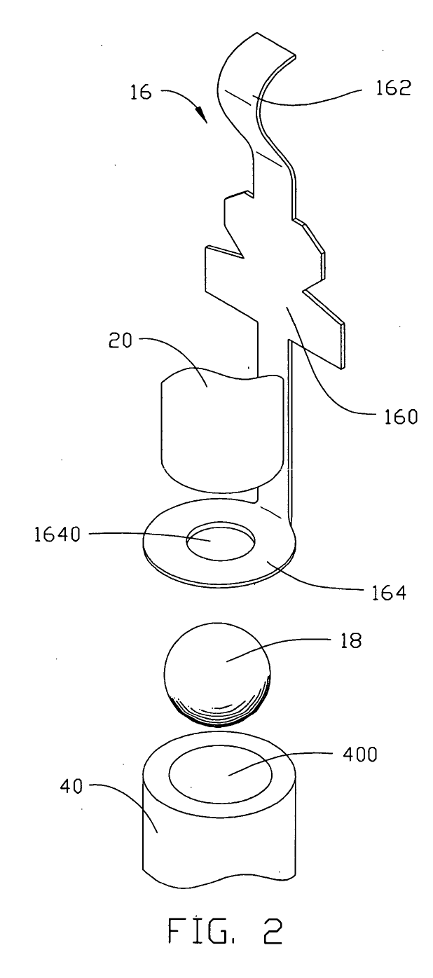

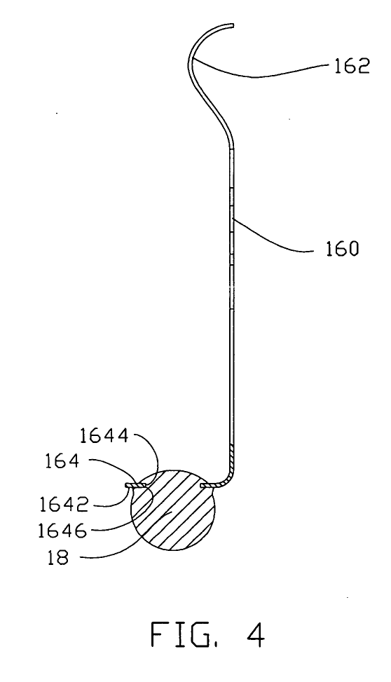

Referring to FIG. 2 to FIG. 4, the contact 16 comprises a sheet-like base 160 defining an upper end and a lower end, a arch-shaped contacting portion 162 extending from the upper end of the base 160, a Circular sheet of soldering portion 164 perpendicularly connected to the lower end of the base 160. The base 160 is configured to be engaged with corresponding passageway 122 and secure the contact 16 therein. The contacting portion 162 is configured to contact with the electrically conductive foot (not shown) protruding from the IC. The soldering portion 164 defines a planar bottom face 1642 and a round through-hole 1640 through the bottom face 1642 and cutting through the Circular sheet. The through-hole 1640 defines a side cylinder face 1644 perpendicular to the bottom face 1642 and so a sharp point 1646 is shaped where the bottom face and the cylinder face intersects.

In order to solder the contacts 16 of the connector 10 to the PCB, each of the contacts 16 are preplanted with a solder ball 18 before it is inserted into the housing 12. The solder ball 18 is of good plasticity and ready to melt when heated to a low temperature about 190 centigrade degree. The solder-ball-preplanted process includes two steps: firstly, pushing the solder ball 18 perpendicularly to the soldering portion 164 till the solder ball 18 is partly wedged into the through-hole 1640, and the sharp point thrust into the solder ball 18, so that the solder ball is attached to the contact 16 by the interference between the solder ball 18 and the soldering portion 164; then, heating contact 16 till part of the solder ball 18 melts and then cooling down so that the melted solder material solidifies and then the solder ball 18 is firmly connected to the contact 16. Wherein the first step, an upper mold 20 pressing on the soldering portion 164 and a lower mold 40 to push the solder ball 18 to the soldering portion 164 from below are provided so that undesired deformation will not take place about the soldering portion 164.

So when the solder ball 18 is attached to the contact 16, there is no need of viscid flux applied over the bottom face 1642, just wedging the solder ball till part of the solder ball 18 gets into the through-hole 1640, the solder ball 18 will then get stuck to the contact 16 by the interference action between the solder ball 18 and the soldering portion 164. Further more, after the connector 10 is soldered to the PCB, when suffering from the vibration or impulse in working environment, the soldering connection between the bottom face 1642 and the solder ball 18 is easy to produce cracks and then the cracks develop straightly along the bottom face where there are more lattice imperfections, which may lead to the break of the soldering connection. While, in the present invention, the soldering connection includes a portion along the bottom face 1642 and another portion along the cylinder face 1644. The base of the solder ball 18 in the center of the soldering portion 164 is less sensitive to the crack for there are less lattice imperfections therein. So when the crack extends along the bottom face 1642 to the cylinder face 1644, the base in the center of the soldering portion 164 delays further straight developing of the crack which may lead to the break of the soldering connection.

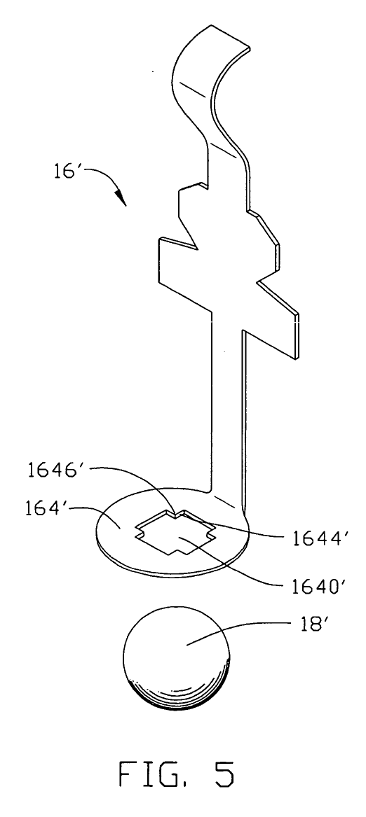

Referring to FIG. 5, a contact 16′ in accordance with an alternatve embodiment of the present invention with a discrete solder ball 18′ is shown. The soldering portion 164′ defines a heterotypic through-hole 1640′ with a plurality of zigzag side faces 1644′. The zigzag faces 1644′ form many sharp points 1646′. When the solder ball 18′ is wedged partly into the through-hole 1640, the sharp points 1646′ thrust into the solder ball 18′, which increases the force the contact 16′ acts on the solder ball 18′. Further more, after the solder ball 18′ is soldered to the soldering portion 164′ of the contact 16, there are many zigzag soldering faces which increas the soldering area of the connection and so the strength of the soldering connection as well.

While preferred embodiments in accordance with the present n have been shown and described, equivalent modifications and known to persons skilled in the art according to the spirit of the invention are considered within the scope of the present invention as in the appended claims.

1. A connector for receiving an IC package, the connector comprising:
a housing defining a plurality of passageways;
an identical number of contacts received in said passageways, each of the contacts comprising a base securely engaged with the corresponding passageway thereby, an arcuate contacting portion extending from an upper end of the base, and a soldering portion connected to a lower end of the base, the soldering portion defining a bottom face, a hole through the bottom face, a side face of the hole, and a sharp point where the bottom face and a side face of the hole intersect, wherein the contact further comprises a solder ball being wedged from below the soldering portion partially into the hole and then soldered to the soldering portion.

2. The connector as described in claim 1, wherein the soldering portion forms a Circular sheet bent to be perpendicular to the base.

3. The connector as described in claim 2, wherein the hole cuts through the soldering portion.

4. The connector as described in claim 3, wherein the hole forms a cylindrical side face perpendicular to the bottom face.

5. The connector as described in claim 3, wherein the hole forms several zigzag faces and sharp points thrusting into the solder ball when the solder ball is wedged partially into the hole.

6. A contact used in a connector that connects an IC package to a printed circuit board, the contact comprising:
a base to secure the contact in the connector, the base defining an upper end and a lower end;
an arch contacting portion extends from the upper end of the base;
a soldering portion connected to the lower end of the base, the soldering portion defining a bottom face and several sharp points therein;
a solder ball being thrust into by said sharp points of the soldering portion and then soldered to the soldering portion.

7. The contact as described in claim 6, wherein the soldering portion forms a Circular sheet perpendicular to the base.

8. The contact as described in claim 7, wherein the soldering portion defines a hole cutting therethrough.

9. The contact as described in claim 8, wherein the hole defines several zigzag faces perpendicular to the bottom face.

10. A method of making an electrical contact comprising steps of:
providing an electrical contact with a horizontal solder section defining a through hole therein in a vertical direction;
disposing a solder ball under said horizontal solder section wherein a diameter of the solder ball is larger than that of the through hole;
disposing a lower mold under the solder ball and an upper mold above the horizontal solder section; and
moving the upper and lower molds close to each other to have an upper portion of the solder ball riveted within the through hole.
